(19) United States
(12) Patent Application Publication
(10) Pub. No.: US 2010/0091333 A1
(43) Pub. Date: Apr. 15, 2010

(54) Method and Printer System for Reducing Image Print Grain Effect

(76) Inventor: James Ray Bailey, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/248,981

(22) Filed: Oct. 10, 2008

(51) Int. Cl. G06K 15/02

(52) U.S. Cl. 358/3.24

(57) ABSTRACT

A method and an imaging apparatus for reducing print grain effect in an image to be printed by a printing device are disclosed. One or more flat field areas, each comprising at least one flat field pixel, are detected in the image. A color value of each detected flat field pixel in the one or more flat field areas is modified using a unique flat field optimized color lookup table. The modification of the color value of each flat field pixel in the image reduces the print grain effect in the image to be printed by the printing device.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Disclosure

The disclosure relates generally to printing devices, and, more particularly, to reducing a print grain effect in images printed by the printing devices.

2. Description of the Related Art

Printing devices, such as printers, are typically used to output information displayed on a screen of a data processing device, such as a personal computer. The information may be output on a media sheet, such as a sheet of paper. Outputting, or printing, the information on the media sheet refers to placing discrete units of colorants, such as ink droplets, on the media sheet corresponding to the information to be printed on the media sheet.

For printing the information, such as an image, a printing device performs a color conversion of each pixel in an image, by converting a color value of each pixel from a Red-Green-Blue (hereinafter ‘RGB’) color notation to a Cyan-Magenta-Yellow-Black (hereinafter ‘CMYK’) color notation using a traditional color lookup table. The RGB color notation is typically used by a data processing device for displaying digital images on a screen while a CMYK color notation is typically used by media processing devices, such as printers for printing the information.

Use of the traditional color lookup table to convert each pixel found in an image from the RGB color notation to the CMYK color notation is well known in the art. The traditional color lookup table includes color conversion values for each pixel color value. For a given RGB color value of a pixel in an image, a color conversion corresponding to the CMYK color value is obtained from the traditional color lookup table. The printing device then instructs a printing mechanism in the printing device to place specified units of colorants corresponding to the obtained CMYK color value on the media sheet for printing the pixels on the media sheet.

As explained above, a traditional color lookup table is typically used by the printing device for converting an entire image from the RGB color notation to the CMYK color notation. The traditional color lookup table may include both high frequency colorant values (corresponding to high frequency colorant drops) and low frequency colorant values (corresponding to low frequency colorant drops) for converting the entire image to be printed from the RGB color notation to the CMYK color notation. The traditional color lookup table must typically provide a requisite transition between both the high frequency colorant drops and the low frequency colorant drops for ensuring smooth gradients and for precluding noticeable defects in the image to be printed on the media sheet.

However in areas of the image where the pixel color values are constant, the low frequency colorant drops are typically a source of a noticeable print grain effect printed onto the media sheet. When the pixel color values are constant or near constant, this is termed a ‘flat field’ area of an image, containing flat field pixels. When such pixels are a part of a flat field area, low frequency colorant drops will form a grainy print manifested as colorant drops being misplaced on the media sheet or the occurrence of individual colorant drops being large enough to be noticeable to human eye. Elimination of the low frequency colorant drops would reduce this print grain effect. However, eliminating the low frequency colorant drops altogether from the pixel color values of the image may result in unacceptable print gradients which also adversely affects quality of the print image.

Based on the foregoing, there is a need for reducing a print grain effect in an image to be printed by a printing device. Further, there exists a need for reducing the print grain effect caused by low frequency colorant drops in flat field areas of the image. Furthermore, there exists a need for reducing the print grain effect while precluding degradation in quality of any other feature of the image.

### SUMMARY OF THE DISCLOSURE

In view of the foregoing disadvantages inherent in the prior art, the general purpose of the present disclosure is to provide a method and imaging apparatus product for reducing print grain effects in an image to be printed by a printing device to include all the advantages of the prior art, and to overcome the drawbacks inherent therein.

Accordingly, in one aspect, the present disclosure provides a method for reducing print grain effects in an image to be printed by a printing device. The method includes the steps of detecting pixels in an image, classifying each pixel in an image as one of either a flat field pixel or a non flat field pixel using a flat field pixel detection means, filtering the flat field/non flat field classification results to eliminate visually insignificant areas detected as flat fields and modifying a color value of each detected, filtered flat field pixel.

The invention, in another form thereof, relates to an imaging apparatus. The imaging apparatus includes a print engine configured to mount a production printing cartridge, and a controller communicatively coupled to the print engine. The controller executes the instructions to perform the steps of detecting pixels in an image, classifying each pixel in an image as one of either a flat field pixel or a non flat field pixel using a flat field detection means, filtering the flat field/non flat field classification results to eliminate visually insignificant areas detected as flat fields and modifying a color value of each detected, filtered flat field pixel.

In the present invention, the modification of the color value of each flat field pixel is achieved by converting a color value of each flat field pixel in one or more flat field areas from a first color notation such as a RGB to a second color notation such as CMYK using a unique flat field optimized color lookup table. In another embodiment of the invention, the conversion of the color values of each flat field pixel from a first color notation to a second color notation may also be achieved dynamically without using any color lookup tables. Color compensating each flat field pixel prior to printing the image onto the media sheet using the unique flat field optimized color lookup table of the present invention eliminates the low frequency colorant drops, thereby reducing noticeable print grain effect in the printed image. Further, a reduction in the print grain effect in the image is achieved without degrading any other quality of the printed image. An advantage of the present invention is that print quality is dramatically improved by eliminating grain caused by low frequency drops.

### BRIEF DESCRIPTION OF THE DRAWINGS

The above-mentioned and other features and advantages of this present disclosure, and the manner of attaining them, will become more apparent and the present disclosure will be better understood by reference to the following description of embodiments of the disclosure taken in conjunction with the accompanying drawings, wherein:

FIG. 1 is a diagramanic depiction of an imaging system that utilized the present invention;

FIG. 2 is a diagramanic depiction of a color space converter accessing a color conversion lookup table in accordance with the present invention.

FIG. 3 shows a schematic depiction of a flow chart depicting a method according to the present invention.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. The use of “including”, “comprising” or “having” and variations thereof herein is meant to encompass the items listed thereafter and equivalents thereof as well as additional items.

In addition, it should be understood that embodiments of the present disclosure include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the present disclosure may be implemented in software. As such, it should be noted that a plurality of hardware and software-based devices, as well as a plurality of different structural components may be utilized to implement the present disclosure. Furthermore, and as described in subsequent paragraphs, the specific mechanical configurations illustrated in the drawings are intended to exemplify embodiments of the present disclosure and that other alternative mechanical configurations are possible.

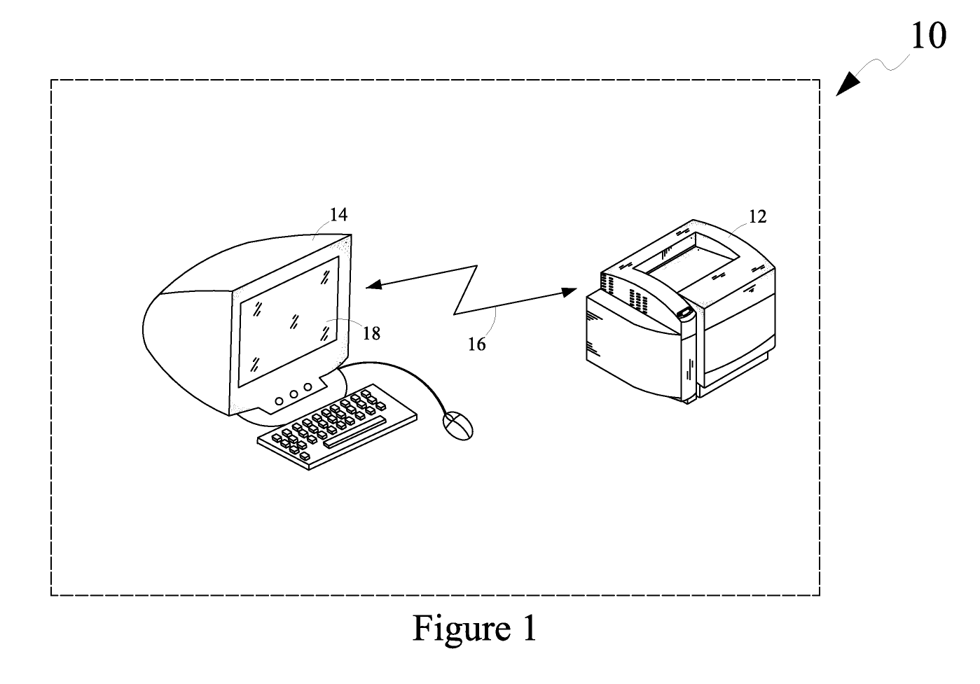

Referring now to the drawings, and particularly to FIG. 1, there is shown a diagrammatic depiction of an imaging system 10 embodying the present invention. Imaging system 10 includes an imaging apparatus 12 and a host 14. Imaging apparatus 12 communicates with host 14 via a communications link 16 or a wireless technology.

Imaging apparatus 12 can be, for example, an ink jet printer and/or copier, an electrophotographic printer and/or copier, or an all-in-one (AIO) unit that includes a printer, a scanner, and possibly a fax unit. Imaging apparatus 12 includes a controller 18, a print engine 20, a printing cartridge, such as production printing cartridge 22 having cartridge memory 24, and a user interface 26. Imaging apparatus 12 has access to a network 28, such as the Internet, via a communication line 30, or a wireless technology to interface with an offsite computer 32 having an offsite memory 34, in order to transmit and/or receive data for use in carrying out its imaging functions.

Controller 18 includes a processor unit and associated memory 36, and may be formed as one or more Application Specific Integrated Circuits (ASIC). Controller 18 may be a printer controller, a scanner controller, or may be a combined printer and scanner controller. Although controller 18 is depicted in imaging apparatus 12, alternatively, it is contemplated that all or a portion of controller 18 may reside in host 14. Controller 18 communicates with print engine 20, production printing cartridge 22, and cartridge memory 24 via a communications link 38, and with user interface 26 via a communications link 42. Controller 18 serves to process print data and to operate print engine 20 during printing.

In the context of the examples for imaging apparatus 12 given above, print engine 20 can be, for example, an ink jet print engine or a color electrophotographic print engine, configured for forming an image on a printing substrate 44, which may be one of many types of print media, such as a sheet of plain paper, fabric, photo paper, coated ink jet paper, greeting card stock, transparency stock for use with overhead projectors, iron-on transfer material for use in transferring an image to an article of clothing, and back-lit film for use in creating advertisement displays and the like. As an ink jet print engine, print engine 20 operates production printing cartridge 22 to eject ink droplets onto printing substrate 44 in order to reproduce text or images, etc. As an electrophotographic print engine, print engine 20 causes production printing cartridge 22 to deposit toner onto printing substrate 44, which is then fused to printing substrate 44 by a fuser (not shown).

Host 14 may be, for example, a personal computer, including memory 46, an input device 48, such as a keyboard, and a display monitor 50. A peripheral device 52, such as a digital camera, is coupled to host 14 via a communication link 54. Host 14 further includes a processor, input/output (I/O) interfaces, and is connected to network 28 via a communication line 56, and hence, has access to offsite computer 32, including offsite memory 34. Memory 46 can be any or all of RAM, ROM, NVRAM, or any available type of computer memory, and may include one or more of a mass data storage device, such as a floppy drive, a hard drive, a CD-ROM and/or a DVD unit,

During operation, host 14 includes in its memory 46 a software program including program instructions that function as an imaging driver 58, e.g., printer/scanner driver software, for imaging apparatus 12. Imaging driver 58 is in communication with controller 18 of imaging apparatus 12 via communications link 16. Imaging driver 58 facilitates communication between imaging apparatus 12 and host 14, and provides formatted print data to imaging apparatus 12, and more particularly, to print engine 20. Although imaging driver 58 is disclosed as residing in memory 46 of host 14, it is contemplated that, alternatively, all or a portion of imaging driver 58 may be located in controller 18 of imaging apparatus 12.

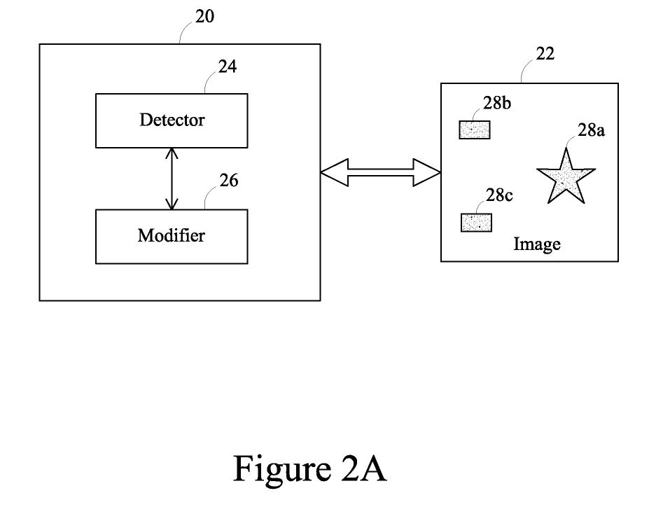

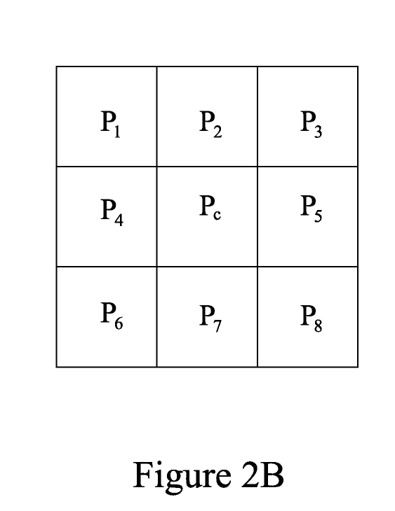

Referring now to FIG. 2, imaging driver 58 includes a colorspace converter 60. Although described herein as residing in imaging driver 58, colorspace converter 60 may be in the form of firmware or software, and may reside in either imaging driver 58 or controller 18. Alternatively, some portions of colorspace converter 60 may reside in imaging driver 58, while other portions reside in controller 18.

Colorspace converter 60 is used for converting color signals from a first colorspace, such as an RGB colorspace output by display monitor 50, to a second colorspace, for example, CMYK, which is used by print engine 20. Coupled to the colorspace converter 60 are a traditional color lookup table 62 and a flat field optimized color lookup table 64.

Traditional color conversion lookup table 62 is the basic or standard color lookup table known in the art which is accessed by colorspace converter 60 of imaging apparatus 12 and imaging system 10 for performing color conversion. Flat field optimized color lookup table 64 is specifically associated with the present invention, forming an inventive component used in the color conversion process of detected flat field pixels.

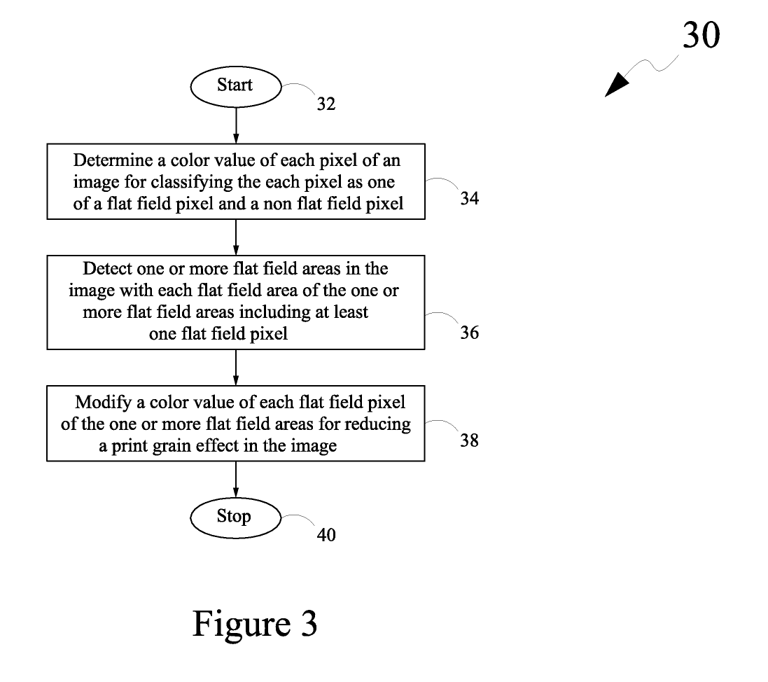

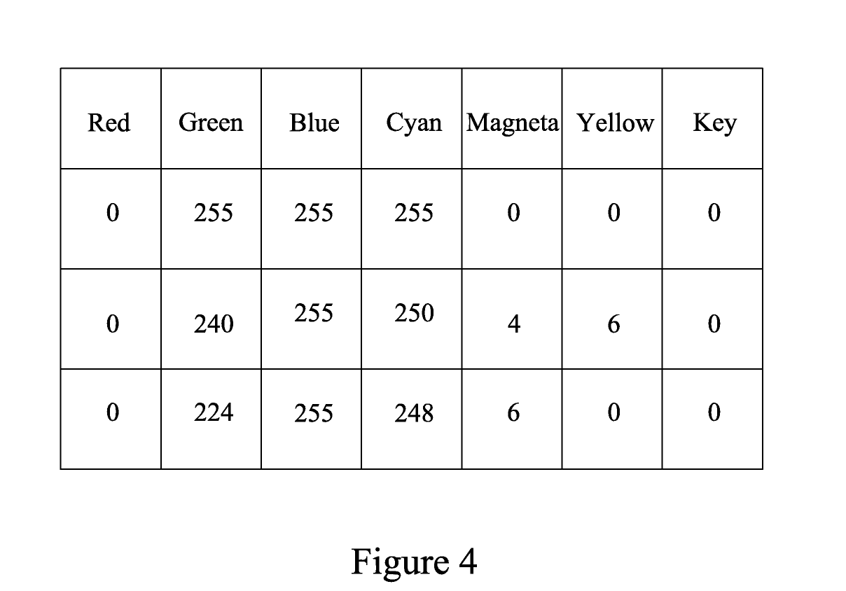

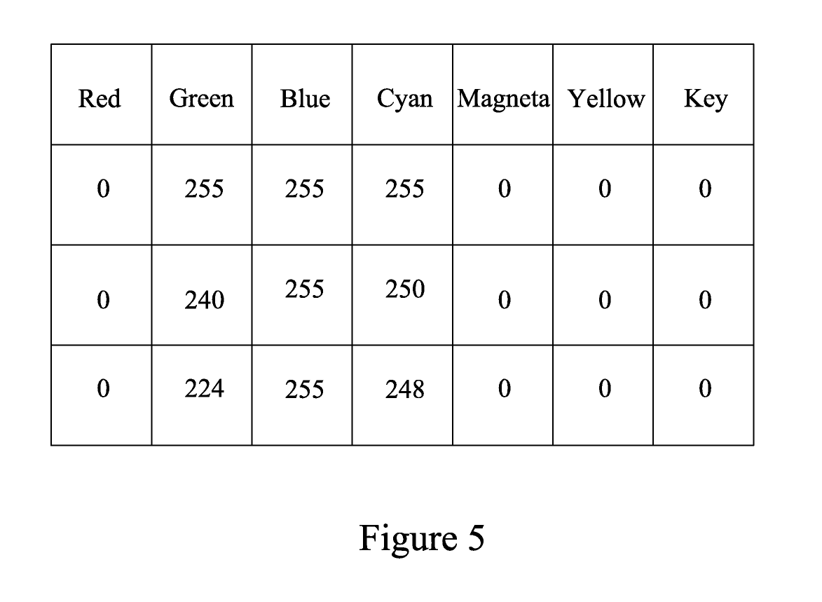

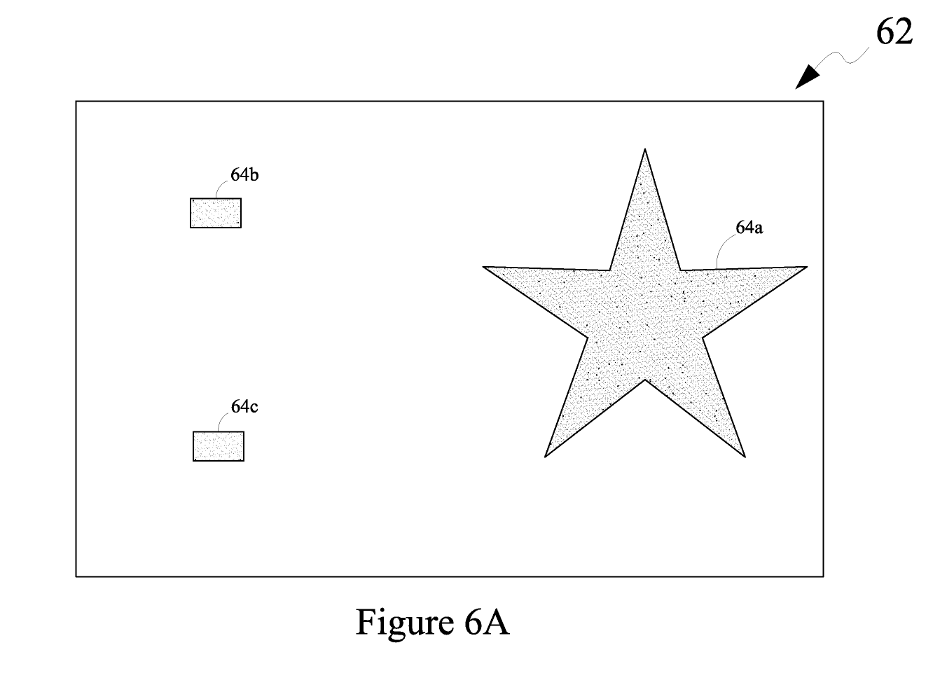

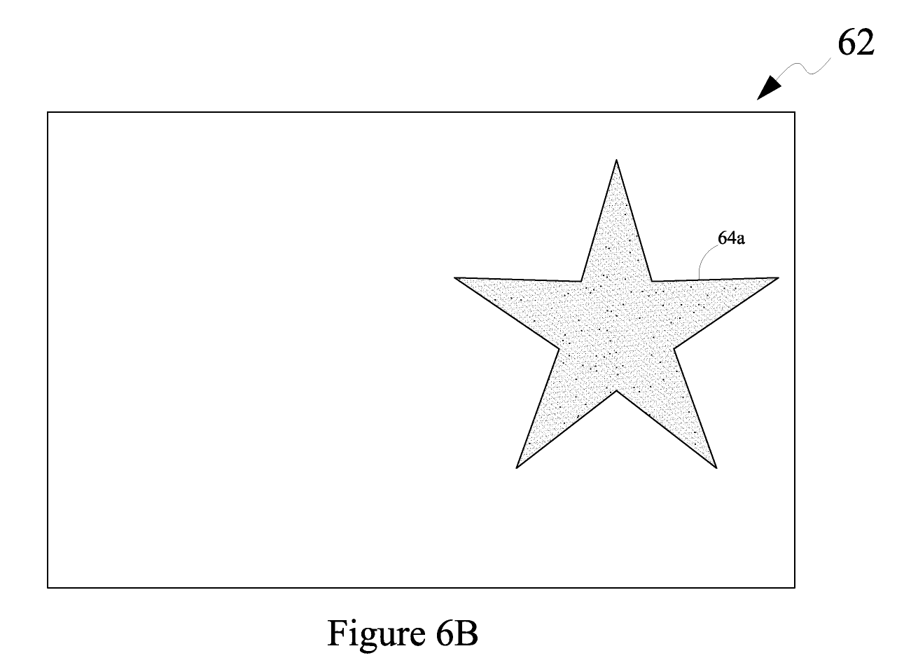

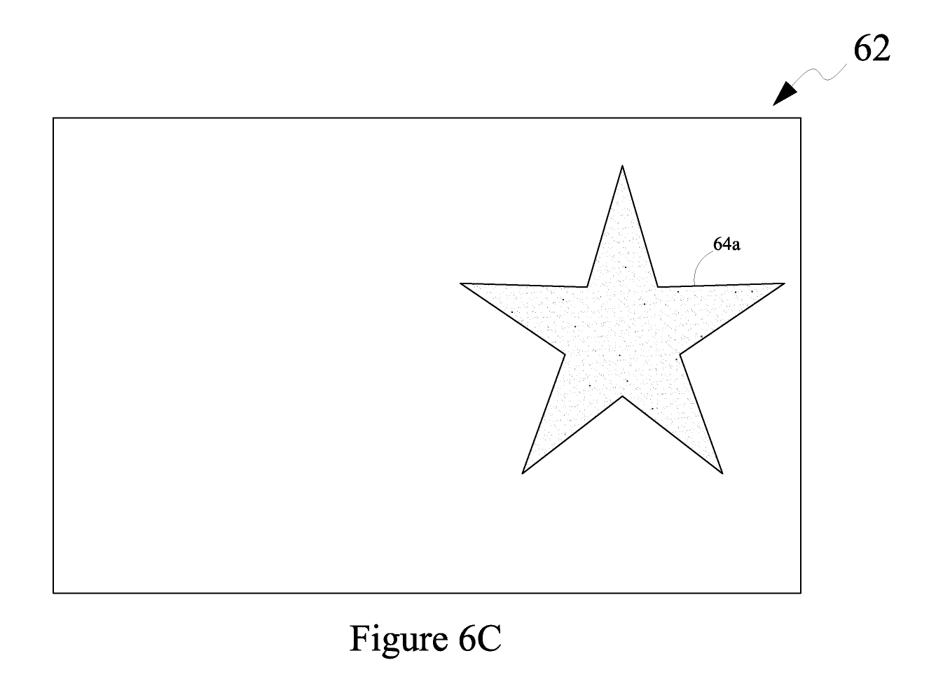

Referring now to FIG. 3, there is generally depicted a method S300 for reducing a print grain effect in an image to be printed by a printing device. At S302, a pixel of an image is detected. At S304, each detected pixel of an image is classified to be either a flat field pixel or a non flat field pixel by applying a flat field detection algorithm on each said pixel. In one embodiment of the present disclosure, the pixel may be classified as a flat field pixel by first determining a difference between its color value and at least one neighboring pixel's color value and second by determining if the calculated difference is less than a predetermined threshold. If the difference is less than a predetermined threshold, then the pixel is classified as a flat field pixel. If the difference is equal to or greater than a predetermined threshold, then the pixel is classified as a non flat field pixel. The detected non flat field pixels from S304 go through the color conversion process by applying a traditional color lookup table. Detected flat field pixels from S304 are then filtered at S306 to eliminate visually insignificant areas that are detected as flat fields. A morphological erosion filter is applied at S306 to the classification results from S304 to eliminate visually insignificant areas of detected flat fields. Such morphological erosion filters are well known in the art. At S308, a color value of each detected, filtered flat field pixel is modified to reduce a print grain effect. In one embodiment, the modification of the color value for a detected, filtered flat field pixel is accomplished by applying a flat field optimized color lookup table on each flat field pixel instead of the traditional color lookup table. In another embodiment, the color value of each detected, filtered flat field pixel may be dynamically modified based on the color value of the flat field pixel when compared against a predetermined threshold.

As described hereinabove, in order to eliminate low frequency color drops inside flat field areas, such areas of an image must first be detected and classified correctly. The detection step 302 and classification step 304 shown in FIG. 3 are more fully described below.

In the preferred embodiment, a n×n spatial window is applied across an RGB image. A 3×3 spacial window is used below for exemplary purposes. Within that 3×3 spatial window, the differences in color value between the center pixel or P_{c} and the color value of its surrounding pixels P₁ to P₈ are calculated. If those differences are less than a predefined threshold, that pixel is classified to be a flat field pixel and hence part of a flat field area. If those differences are equal to or greater than a predefined threshold, that pixel is classified to be a non flat field pixel and hence part of a non flat field area. Accordingly, each pixel in the image is identified as being a part of a flat field area or not by calculating its color value and comparing this value to a color value of at least one neighboring pixel. Equation 1 illustrates this concept:

$$\begin{matrix}{P}_{1} & {P}_{2} & {P}_{3} \\ {P}_{4} & {P}_{5} & {P}_{6} \\ {P}_{7} & {P}_{8} & {P}_{9}\end{matrix} \\ If \vert ( {P}_{c} - {P}_{x} ) \vert < Predetermined Threshold Value for x = 1 , 2 , 3 , 4 , 5 , 6 , 7 , 8 \\ then {P}_{c} = Flat field Pixel \\ Else \\ {P}_{c} = Non Flat field Pixel \qquad Equation 1$$

For the present invention as way of an example, the value of the predetermined threshold value is chosen to be about 10 percent of the maximum color value of the pixel and at least one neighboring pixel. Therefore, if the difference between a color value of the pixel and a color value of at least one neighboring pixel, which range from 0 to 255, is less than 25, the pixel P_{c} may be classified as a flat field pixel. If the difference is equal to or greater than 25, then P_{c} is classified as a non flat field pixel. However, it should be understood that the above stated values of the predetermined threshold value, the range of the color value of the pixel, and the range of the color value of at least one neighboring pixel is only for exemplary purposes. Other methods of detecting flat fields in an image can be utilized as long as for each individual pixel there is a corresponding value that specifies if that pixel is a part of a flat field

As shown in FIG. 3, the detected flat field pixels found in one or more flat field areas may be filtered at S306 to eliminate those flat field areas which include a substantially low concentration of flat field pixels. Those skilled in the art will recognize that morphological operations, such as erosion filtering, may be used for this filtering step. This filtering is done to prevent the flat field pixel modifications done at S308 of visually insignificant sized areas of an image.

The modification step at S308 uses a unique flat field optimized color lookup table to modify the color values of the detected, filtered flat field pixels. An exemplary embodiment of creating the flat field optimized color lookup table of the present invention is described herein. Table 1 shows the values of a portion of a traditional color lookup table. The input RGB color values are depicted with the corresponding output CMYK color values used during a color conversion operation. As can be seen in Table 1, for a pixel of an image with a color value corresponding to RGB triplet of (0, 240, 255), the corresponding converted CMYK value is (250, 4, 6, 0). Thus, the pixel of the image will include nearly solid cyan (250/255=98%) and negligible amount of magenta (4/255=1.6%). Low frequency colorant drops such as the negligible amount of magenta in flat field areas of the image may result in noticeable print grain effect.

TABLE 1

| Red | Green | Blue | Cyan | Magenta | Yellow | Key |
|---|---|---|---|---|---|---|
| 0 | 255 | 255 | 255 | 0 | 0 | 0 |
| 0 | 240 | 255 | 250 | 4 | 6 | 0 |
| 0 | 224 | 255 | 248 | 6 | 0 | 0 |

In order to create a flat field optimized color table from the traditional color lookup table as shown in Table 1, the value given to each output CMYK is compared against a predetermined threshold. If the given output is less than the predetermined threshold, the corresponding output value for the flat field optimized color lookup table is set to zero. This is shown in Table 2 below. If the given output value is greater than the predetermined threshold, the corresponding output value for the flat field optimized color lookup table is unchanged from the traditional color lookup table. Other methods of eliminating low frequency color values in a flat field optimized color lookup table may be utilized and will be apparent to those skilled in the art.

TABLE 2

| Red | Green | Blue | Cyan | Magenta | Yellow | Key |
|---|---|---|---|---|---|---|
| 0 | 255 | 255 | 255 | 0 | 0 | 0 |
| 0 | 240 | 255 | 250 | 0 | 0 | 0 |
| 0 | 224 | 255 | 248 | 0 | 0 | 0 |

In another embodiment of the present invention, the color value of each flat field pixel is modified by dynamically modifying a color notation of each flat field pixel from the first color notation to the second color notation for color compensating each flat field pixel. Dynamically modifying the color notation of each flat field pixel precludes use of any color lookup tables, and, as such a color conversion value may be computed for each flat field pixel instantaneously based on techniques known in the art.

It will be apparent to a person skilled in the art that the present disclosure as described above, may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the present disclosure. When implemented on a general-purpose microprocessor, the computer program code segments configure the microprocessor to create specific logic circuits.

The foregoing description of several methods and an embodiment of the present disclosure have been presented for purposes of illustration. It is not intended to be exhaustive or to limit the present disclosure to the precise steps and/or forms disclosed, and obviously many modifications and variations are possible in light of the above description. It is intended that the scope of the present disclosure be defined by the claims appended hereto.

What is claimed is:

1. A method for reducing print grain effect in an image to be printed by a printing device, the method comprising:
detecting one or more flat field areas in the image, each flat field area of the one or more flat field areas comprising at least one flat field pixel; and
modifying a color value of each flat field pixel of a flat field area, wherein the color value modification of each flat field pixel in the image reduces the print grain effect in the image to be printed by the printing device.

2. The method of claim 1 wherein modifying the color value of each flat field pixel comprises converting a color notation of each flat field pixel from a first color notation to a second color notation using a flat field optimized color lookup table.

3. The method of claim 2 wherein the flat field optimized color lookup table comprises color conversion values for color compensating each flat field pixel.

4. The method of claim 3 wherein the flat field optimized color lookup table precludes low frequency color conversion values for color compensating each flat field pixel.

5. The method of claim 2 wherein the first color notation is a Red-Green-Blue (RGB) color notation and the second color notation is a Cyan-Magenta-Yellow-Black (CMYK) color notation.

6. The method of claim 1 wherein modifying the color value of each flat field pixel comprises dynamically modifying a color notation of each flat field pixel from a first color notation to a second color notation.

7. The method of claim 1 further comprising determining a color value for each pixel of the image whereby each pixel is classified as either a flat field pixel or a non flat field pixel.

8. The method of claim 7 wherein each pixel of the image is classified as a flat field pixel upon determining the difference between a color value of the pixel and a color value of at least one neighboring pixel being less than a predetermined threshold value.

9. The method of claim 7 wherein the pixel of the image is classified as a non flat field pixel upon determining the difference between a color value of the pixel and a color value of at least one neighboring pixel being equal to or greater than a predetermined threshold value.

10. The method of claim 1 further comprising the steps of filtering the one or more detected flat field areas, whereby the filtering eliminates the detected areas of flat fields that are too small to compensate for low frequency drops.

11. An imaging apparatus, comprising:
a print engine configured to mount a print cartridge, and;
a controller communicatively coupled to said print engine, said controller executing instructions to perform the steps of:
detecting one or more flat field areas in the image, each flat field area of the one or more flat field areas comprising at least one flat field pixel; and
modifying a color value of each flat field pixel of a flat field area of the one or more flat field areas,
wherein the color value modification of each flat field pixel in the image reduces the print grain effect in the image to be printed by the printing device.

12. The imaging apparatus of claim 11 wherein modifying the color value of each flat field pixel comprises converting a color notation of each flat field pixel from a first color notation to a second color notation using a flat field optimized color lookup table, the flat field optimized color lookup table contains color conversion values for color compensating each flat field pixel.

13. The imaging apparatus of claim 11 wherein modifying the color value of each flat field pixel comprises dynamically modifying a color notation of each flat field pixel from a first color notation to a second color notation.

14. The imaging apparatus of claim 11, said controller further executing instructions to perform the step of: classifying a pixel as a flat field pixel upon determining a difference between a color value of the pixel and a color value of at least one neighboring pixel being less than a predetermined threshold value.

15. The imaging apparatus of claim 11, said controller further executing instructions to perform the step of: classifying a pixel as a non flat field pixel upon determining a difference between a color value of the pixel and a color value of at least one neighboring pixel being equal to or greater than a predetermined threshold value.

16. The imaging apparatus of claim 11, said controller further executing instructions to perform the step of filtering the one or more detected flat field areas whereby the filtering eliminates the detected areas of flat fields that are too small to compensate for low frequency drops.
